(19) United States
(12) Patent Application Publication
(10) Pub. No.: US 2006/0093707 A1
(43) Pub. Date: May 4, 2006

(54) Method for making a deep-frozen intermediate product for sweet or savoury pie and resulting intermediate product

(76) Inventor: Daniel Peyrat, Champigny (FR)

Correspondence Address: CONNOLLY BOVE LODGE & HUTZ LLP, SUITE 800, 1990 M STREET NW, WASHINGTON, DC, 20036-3425, US

(21) Appl. No.: 10/517,817

(22) PCT Filed: Jun. 13, 2003
(86) PCT No.: PCT/FR03/01785

§ 371 Date: Jul. 29, 2005

(30) Foreign Application Priority Data
Jun. 14, 2002 (FR) 02/07335

(51) Int. Cl. A21D 13/00

(52) U.S. Cl. 426/94

(57) ABSTRACT

The method comprises steps consisting in: preparing a pastry dough, part-baking the pastry dough, shaped in a mold, in an oven to obtain a part-baked pie base; preparing a filling such as a cream or quiche filling, assembling the part-baked pie base with the filling to obtain a deep-frozen preparation comprising the filling disposed on the pie base, and packaging the intermediate product obtained. This enables a sweet or savory pie to be produced by adding a garnish and final baking to finish baking the pie base.

### FIELD OF THE INVENTION

The invention relates to the manufacture of deep-frozen intermediate products for sweet or savory pies. The term “sweet or savory pie” as used here means a product which is usually termed a pie, tartlet, quiche, or tart comprising a pastry base, in particular short pastry, puff pastry, or shortbread pastry, a filling, in particular cream, flan, quiche filling, etc, and a garnish, for example fruit, chocolate in various forms, cheese, diced bacon, vegetables, meat, fowl, or seafood in pieces, optionally embellished with a decoration.

Current commercially available pies or quiches are in the form of deep-frozen finished products which need only to be defrosted prior to serving. The choice is limited and the user has no chance of offering a personalized product for consumption.

Uncooked deep-frozen pie bases or baked pie bases stored at ambient temperature are also known, which have to be filled with a filling before heating the base and cooking the filling, and positioning a garnish. Those products can be personalized, but producing a perfectly baked pie in which the pastry remains crisp is very difficult, particularly in a ventilated or rototherm oven.

This is also the case with preparations comprising a baked pie base filled with a baked filling, with the assembly being deep-frozen.

A great deal of prior art exists which pertains to the preparation of deep-frozen pre-cooked pizza bases.

However, techniques used for pizzas cannot, a priori, be transferred to sweet or savory pies. Indeed
the composition of pizza dough differs from that of short, puff, or shortbread pastry;
for a pizza, a completely crisp dough is not desirable; it should have a certain degree of softness even if the surface is crisp; reference can be made in this respect to United States patent U.S. Pat. No. 6,365,210 which recommends moistening the uncooked pizza dough before pre-baking it to prevent its surface from achieving a golden appearance too soon;
compared with a savory or sweet pie, a pizza comprises a much smaller quantity of ingredients with respect to the dough, so that baking is less influenced by the garnish; in contrast, one difficulty with savory or sweet pies is in obtaining a crisp pastry in the presence of a relatively large quantity of liquid filling (cream, flan, quiche filling).

### OBJECT AND SUMMARY OF THE INVENTION

The invention aims to provide a method of producing deep-frozen intermediate products for sweet or savory pies offering the possibility of personalizing finished products very easily and permitting the production of finished pies with a pastry dough which has an improved durable crust compared with prior art products.

The aim is achieved by a method comprising steps consisting in:
preparing a pastry dough;
partially baking the pastry dough, shaped in a mold, in an oven to obtain a part-baked pie base;
preparing a filling;
assembling the part-baked pie base with the filling to obtain a deep-frozen intermediate product comprising the filling disposed on the pie base; and
packaging the preparation obtained.

The method of the invention is remarkable in that the pastry dough base is separately pre-baked, while being kept in shape in a mold, prior to deep-freezing. Said part-baking has the advantage of preventing any significant migration of moisture from the filling and thus of obtaining a crisp pastry after final baking while reducing the duration of the final baking.

Advantageously, part-baking of the pastry is carried out by maintaining it in shape between a mold and a perforated backing-mold inside the pie base. In this manner, steam can escape from the orifices of the counter-mold.

In accordance with one implementation, the filling is poured or deposited onto the part-baked pie base before deep-freezing the assembly.

In accordance with a further implementation, the filling is molded and deep-frozen before being disposed, in the frozen state, on the part-baked pie base. Thus, the filling is not in contact in a pasty or liquid state with the part-baked pie base before reheating and final baking. In this case, the deep-frozen filling can be disposed on the part-baked deep-frozen pie base, or it can be disposed on the part-baked and not deep-frozen pie base with deep-freezing being carried out subsequently.

### BRIEF DESCRIPTION OF THE DRAWINGS

The invention will be better understood from the following description made by way of non limiting indication with reference to the accompanying drawings in which:

FIG. 1 shows steps in a method of producing a deep-frozen intermediate product in accordance with one implementation of the invention;

FIG. 2 shows a highly diagrammatic mold and counter-mold assembly for part-baking the pastry dough in accordance with one step of the method of FIG. 1;

FIG. 3 shows steps in making a deep-frozen intermediate product in accordance with a further implementation of the invention; and

FIG. 4 shows a variation of the implementation of FIG. 3.

### DETAILED DESCRIPTION OF IMPLEMENTATIONS

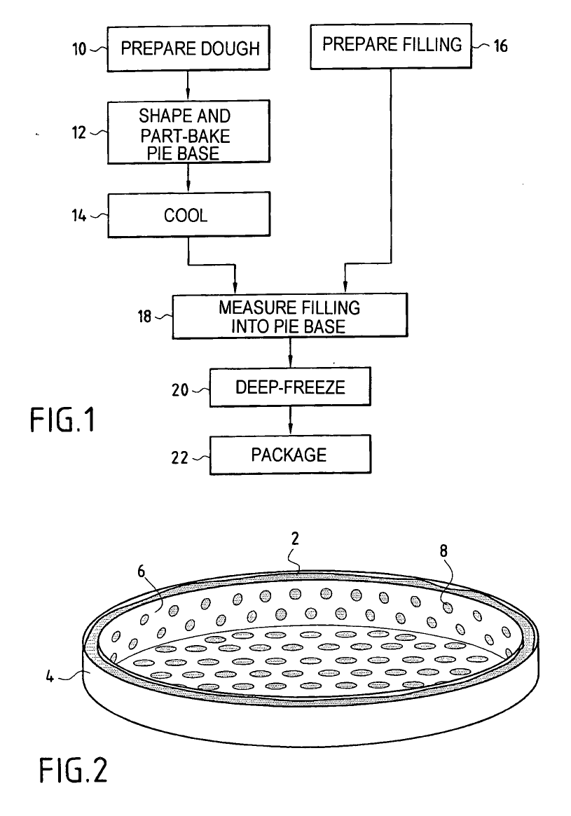

As can be seen in FIG. 1, the method comprises separate production of a pie base and a filling.

Producing the pie base comprises producing a pastry dough (step 10), in particular a short, puff or shortbread pastry dough. It is produced conventionally by mixing and kneading the usual ingredients.

After resting, a mold is lined and the formed pastry dough in the mold undergoes part-baking (step 12).

FIG. 2 shows the dough 2 maintained in shape between a mold 4 and a counter-mold 6 which are applied to the outer and inner faces of the formed pie base. Advantageously, the sides of the mold and counter-mold frame the side of the pie base up to the top thereof.

The counter-mold 6 is perforated by perforations 8 in its base and optionally its side. The perforations evacuate steam during the part-baking of the pie base. The presence of the mold and counter-mold along with the side of the latter prevents the edge of the pie base from falling off (which can occur with a short or shortbread pastry) or shrinkage of said side (in the case of a puff pastry).

Part-baking can be carried out by placing the mold on an oven belt at a temperature which is normal for baking pastry. Part-baking is preferably sufficient to prevent moisture from migrating into the pie base or at least to limit it to a large extent. By way of indication, the duration of part-baking can be in the range 30% to 70% of the normal total baking time for the pie base.

It should be noted that part-baking can also be carried out in a ventilated oven.

After part-baking, the pie base is allowed to cool and may be unmolded, or the reverse (step 14).

The filling intended to fill the pie base is produced separately (step 16). It may be a cream, a flan, a quiche filling or something else, normally in a liquid or paste form.

Producing the filling comprises mixing ingredients and optional at least part-baking.

A predetermined dose of filling is poured into the pie base, which is preferably cooled (step 18) then the assembly is deep-frozen (step 20) and is then packaged, for example individually (step 22). Deep-freezing is carried out under normal food industry conditions.

This produces an intermediate deep-frozen product comprising a part-baked pie base garnished with a filling adhering to the base.

To prepare a finished product ready for consumption, the deep-frozen intermediate product is provided, in the defrosted or not defrosted state, with a garnish (or embellishments) to personalize the product before final baking.

Final baking can be carried out in a ventilated oven. It is aimed at finishing baking of the pastry and to carry out or finish baking the filling when it has been deep-frozen in the uncooked or part-baked state.

When the garnish is positioned before defrosting, a first final baking phase can be carried out by covering the pie with a cover to prevent exposing the garnish to the full heat of the oven during defrosting and baking.

Depending on the nature of the garnish, it can be positioned after baking. This is particularly the case and is known when producing certain fruit pies.

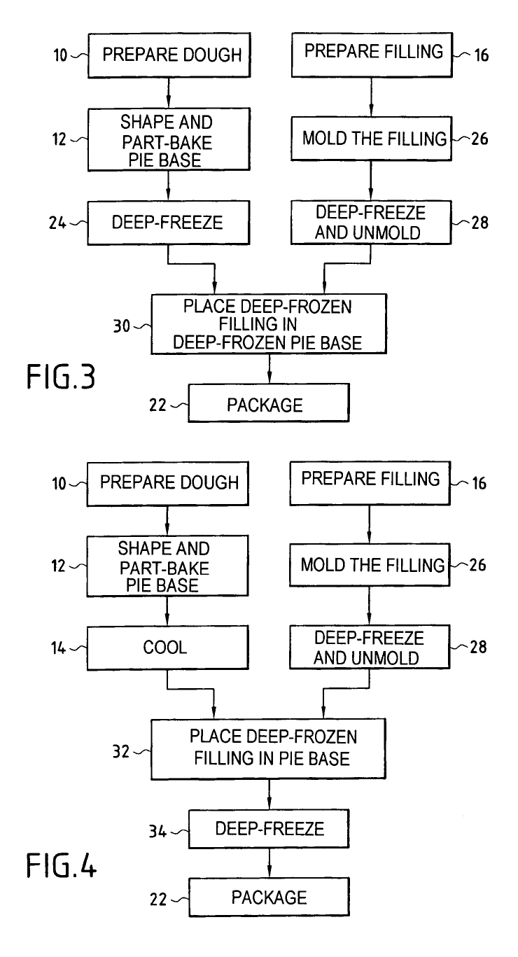

FIG. 3 illustrates a further mode for carrying out the method of the invention.

Steps 10 and 12 for preparing the pastry dough and shaping and part-baking of the pie base are again present. The method is distinguished from that of FIG. 1 in that the part-baked pie base is deep-frozen (step 24) prior to positioning the filling.

The filling is prepared as in the implementation of FIG. 1 (step 16) then it is poured into a mold the dimensions of which correspond to those of the pie base (step 26). The molded filling is then deep-frozen and unmolded (step 28) before being placed in the part-baked and deep-frozen pie base (step 30). The assembly is then packaged, as in the method of FIG. 1 (step 22).

This produces a deep-frozen intermediate product comprising a deep-frozen part-baked pie base filled with a filling that does not adhere to the base.

In a variation, as shown in FIG. 4, a part-baked pie base is produced as described in the method of FIG. 1 (steps 10, 12, 14) and a molded and deep-frozen filling is prepared as described in the method of FIG. 2 (steps 16, 26, 28).

The molded and deep-frozen filling is positioned in the part-baked and not deep-frozen pie base (step 32), then deep-freezing is carried out (step 34) to deep-freeze the pie base before packaging (step 22).

A deep-frozen intermediate product is obtained with a part-baked pie base filled with a filling that does not adhere to the pie base.

In the implementation of FIG. 3 and the variation in FIG. 4, there is no contact of the non deep-frozen filling (liquid or paste) with the non deep-frozen pie base prior to final use of the product, which further reduces the risk of moisture migrating into the pie base. However, in comparison with the method of FIG. 1, two deep-freezing steps are necessary.

Examples of the production and use of deep-frozen intermediate products of the invention will now be described by means of illustrations.

### EXAMPLE 1

### Quiche Preparation

A short pastry dough was produced in conventional manner. The pastry dough was shaped into a pie base for about 6 persons by being placed by a mold and perforated counter-mold and underwent part-baking on an oven belt at a temperature of about 180° C. to 210° C. for about 20 minutes. After cooling, the part-baked pie base was unmolded.

A quiche filling was prepared comprising a mixture of eggs, cream, milk and various ingredients such as salt, pepper, starch, flavoring, spices, etc.

The uncooked filing was poured into a part-baked pie base to partly fill it and the assembly was deep-frozen before being packaged.

At the use stage of the intermediate product, a garnish comprising, for example, diced bacon, grated cheese and spices was placed on the filling before or after deep-freezing. Final baking was carried out in a ventilated oven or oven belt for a duration of about 20 minutes (after defrosting). A quiche was obtained in which the pastry remained nicely crisp even though the filling had been poured in the liquid state into the partly baked pie base before deep-freezing.

As already indicated, when placement of the garnish on the filling is done before deep-freezing it, a first phase of defrosting and baking should advantageously be carried out by covering the quiche with a cover to prevent the garnish from being over-exposed to the full heat before the filling softens. The cover was removed at the end of the baking period to allow the garnish to color in the heat.

Since the deep-frozen intermediate product comprised only the pie base and the quiche filling, it offered the consumer a number of possibilities for personalizing the final product by varying the composition of the garnish.

### EXAMPLE 2

### Alsatian Pie Preparation

A short pastry dough was produced in conventional manner. The pastry dough was shaped into a pie base for about 6 persons by being placed between a mold and a perforated counter-mold. Part-baking was carried out on an oven belt at a temperature of about 170° C. to 210° C. for about 20 minutes. After cooling, the part-baked pie base was unmolded and deep-frozen.

An Alsatian cream was prepared, comprising a mixture comprising a confectioner's custard, eggs, sugar and cream.

The uncooked Alsatian cream was molded in a mold with the dimensions of the pie base to be able to fill it over part of its depth, then it was deep-frozen before being placed into the base of the part-baked and deep-frozen pie. The assembly was then packaged.

It should be noted that the deep-frozen separately molded Alsatian cream could be placed into the part-baked pie base before freezing the latter, then deep-freezing the assembly.

At the use stage, a deep-frozen intermediate product offers multiple possibilities for personalizing a final product:
before or after deep-freezing, filling with a ganache possibly reserving the circumference of the pie (a ganache may be used that is in the form of a deep-frozen pre-produced disk), then baking in a ventilated oven at about 170° C. to 210° C. for about 25 to 35 minutes and then garnishing with fresh raspberries around the circumference and with chocolate shavings on the ganache;
before or after defrosting, garnishing with quetsch plums and baking in a ventilated oven at about 170° C. to 210° C. for about 25 minutes; or
before or after defrosting, the preceding procedure is used, replacing the quetsch plums with other fruit: apples, mirabelle plums, peaches, apricots, etc.

### EXAMPLE 3

### Preparation for Pie

A part-baked shortbread pastry pie base was produced as described in Example 2, but it was not deep-frozen.

An egg flan cream was produced, comprising a mixture comprising cream, milk, eggs, vanilla and starches.

The cream was poured uncooked into the part-baked pie base to a portion of its depth, then the assembly was deep-frozen before being packaged.

Such a deep-frozen intermediate product allowed a variety of sweet pies to be produced in the final stage, for example:
before or after defrosting, baking in a ventilated oven at about 170° C. to 210° C. for about 30 minutes, then garnishing with fresh red fruit (strawberries and/or raspberries);
before or after defrosting, garnishing with a lemon cream composed, for example, of lemon pulp, eggs, butter, milk, cream, thickener or gelling agent, and flavoring (a disk of pre-produced deep-frozen lemon cream could be used), baking in a ventilated oven at about 170° C. to 210° C. for about 25 minutes, and decorating with chocolate shavings and/or lemon zest.

### EXAMPLE 4

### Preparation for “Amandine” Pie

A part-baked shortbread pastry pie base was produced as described in Example 2 but was not deep-frozen.

An almond cream was prepared, comprising a mixture comprising almonds, butter, sugar, flour, vanilla and rum.

The uncooked cream was poured into the part-baked pie base to fill it over part of its depth, then the assembly was deep-frozen before being packaged.

At the use stage, an intermediate deep-frozen product could produce a pie by garnishing with pear segments, before or after defrosting, and baking in a ventilated oven at a temperature of about 170° C. to 210° C. for about 30 minutes.

Clearly, in at least some of the above examples, the short or shortbread pastry dough could be replaced by puff pastry dough.

Thus, with a relatively limited number of intermediate deep-frozen products, the invention allows the preparation of many finished products in the form of sweet or savory pies having good gustatory and textural qualities.

1. A method of producing a deep-frozen intermediate product for a sweet or savory pie, the method comprising:
preparing a pastry dough;
partially baking the pastry dough, shaped in a mold, in an oven to obtain a part-baked pie base;
preparing a filling;
assembling the part-baked pie base with the filling to obtain a deep-frozen intermediate product comprising the filling disposed on the pie base; and
packaging the preparation obtained.

2. A method according to claim 1, characterized in that part-baking of the pastry dough is carried out by maintaining it in shape between a mold and a perforated counter-mold inside the pie base.

3. A method according to claim 1, characterized in that part-baking of the pastry dough is carried out for a period in the range of 30% to 70% of the normal total baking time for the pie base.

4. A method according to claim 1, characterized in that the filling is poured into or deposited onto the part-baked pie base before deep-freezing the assembly.

5. A method according to claim 1, characterized in that the filling is molded and deep-frozen before being disposed in the deep-frozen state on the part-baked pie base.

6. A method according to claim 5, characterized in that the deep-frozen filling is disposed on the part-baked deep-frozen pie base.

7. A method according to claim 5, characterized in that the deep-frozen filling is disposed on the part-baked non deep-frozen pie base and the assembly is deep-frozen.

8. A deep-frozen intermediate product for a sweet or savory pie comprising a part-baked pie base containing a filling.

9. A method of producing a sweet or savory pie comprising using the deep frozen intermediate product according to claim 8, adding a garnish, and final baking to finish baking the part-baked pie base.

10. A method according to claim 2, wherein part-baking of the pastry dough is carried out for a period in the range of 30% to 70% of the normal total baking time for the pie base.

11. A method according to claim 2, wherein the filling is poured into or deposited onto the part-baked pie base before deep-freezing the assembly.

12. A method according to claim 3, wherein the filling is poured into or deposited onto the part-baked pie base before deep-freezing the assembly.
